(19) United States
(12) Patent Application Publication
(10) Pub. No.: US 2021/0060860 A1
(43) Pub. Date: Mar. 4, 2021

(54) Discharge Heat Preserving Method and Device for 3D Printer

(71) Applicant: SHANGHAI FUSION TECH CO., LTD., Shanghai (CN)

(72) Inventors: Jianzhe LI, Shanghai (CN); Hua FENG, Shanghai (CN); Junjie ZONG, Shanghai (CN); Wangping LONG, Shanghai (CN)

(21) Appl. No.: 16/759,072

(22) PCT Filed: Oct. 31, 2017
(86) PCT No.: PCT/CN2017/108486

§ 371 Date: Apr. 24, 2020

(30) Foreign Application Priority Data
Oct. 24, 2017 (CN) 2017110034830

(51) Int. Cl. B29C 64/209; B33Y 30/00; B33Y 70/00; B29C 64/106; B29C 64/393; B33Y 10/00; B33Y 50/02

(52) U.S. Cl. CPC B29C 64/209; B33Y 30/00; B33Y 70/00; B29K 2069/00; B29C 64/393; B33Y 10/00; B33Y 50/02; B29C 64/106

(57) ABSTRACT

Discharge heat preserving methods and devices for a 3D printer are disclosed. In some embodiments, a hot airflow is blown to a discharge outlet (111) of a nozzle device (110) mounted on the 3D printer to form a heat preserving area at the discharge outlet (111) of the nozzle device (110). A printing material discharged from the discharge outlet (111) of the nozzle device (110) stays in the heat preserving area for 2-10 s. The hot airflow is blown to the discharge outlet (111) of the nozzle device (110) from a lateral direction of the nozzle device (110). In other embodiments, the printing material discharged from the discharge outlet (111) of the nozzle device (110) stays in the heat preserving area for 3-6 s.

### CROSS REFERENCE TO RELATED APPLICATIONS

This application is the United State national stage entry under 37 U.S.C. 371 of PCT/CN2017/108486 filed on Oct. 31, 2017, which claims priority to Chinese application number 201711003483.0 filed on Oct. 24, 2017, the disclosure of which are incorporated by reference herein in their entireties.

### FIELD OF THE DISCLOSURE

The disclosure relates generally to 3D printing. More specifically, the disclosure relates to discharge heat preserving methods and devices for a 3D printer.

### BACKGROUND

In the 3D printing field, when high-grade engineering plastic (e.g., polycarbonate) is used for printing, due to the physical and chemical properties of the printing material, damage situations such as that the edge of a printing model being warped up and the printing model being ruptured occur very easily under a room temperature. Currently, in order to print a compliant model, a common solution is to make a printing chamber into a closed chamber and heat the entire chamber to form a high-temperature air protection area at the printing material discharge outlet and satisfy printing demand conditions. Since the chamber of the printer is entirely heated in this method, not only the manufacturing cost of the printer is greatly increased, but also a very high power heating device is needed for heating and the energy is greatly wasted because the volume of the chamber which needs to be heated is large.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides a discharge heat preserving method for a 3D printer. A hot airflow is blown to a discharge outlet (111) of a nozzle device (110) mounted on the 3D printer to form a heat preserving area at the discharge outlet (111) of the nozzle device (110). A printing material discharged from the discharge outlet (111) of the nozzle device (110) stays in the heat preserving area for 2-10 s. The hot airflow is blown to the discharge outlet (111) of the nozzle device (110) from a lateral direction of the nozzle device (110).

Optionally, the printing material discharged from the discharge outlet (111) of the nozzle device (110) stays for 3-6 s in the heat preserving area.

In other embodiments, the disclosure provides a discharge heat preserving system for a 3D printer. The system includes a hot air support (200), a blowing mechanism (300), and a heating part (400). A ventilation chamber (210) is arranged inside the hot air support (200) and an air outlet (201) of the ventilation chamber (210) is located in a side surface of a discharge outlet (111) of a nozzle device (110). A blowing mechanism (300) is configured to drive an airflow to pass through the ventilation chamber (210). A heating part (400) is mounted in the ventilation chamber (210) to heat the airflow passing through the ventilation chamber (210). The nozzle device (110) is mounted on a case (120) of the 3D printer. The heated airflow discharged from the ventilation chamber (210) is blown to the discharge outlet (111) of the nozzle device (110).

Optionally, an airflow discharge direction of the ventilation chamber (210) is obliquely arranged relative to an axial direction of the nozzle device (110).

Optionally, the heating part (400) includes a plurality of outlet air heating units (410) sequentially arranged along an airflow discharge direction of the ventilation chamber (210).

Optionally, the ventilation chamber (210) includes an air inlet chamber (211) and an air outlet chamber (212). The air inlet chamber (211) and the air outlet chamber (212) are in communication with each other, The plurality of outlet air heating units (410) are arranged in the air outlet chamber (212).

Optionally, the heating part (400) further includes at least two inlet air heating units (420) uniformly arranged in the air inlet chamber (211).

Optionally, the inlet air heating units (420) and the outlet air heating units (410) are electric heating devices.

Optionally, the air inlet chamber (211) is located above the air outlet chamber (212) and the blowing mechanism (300) is located above the air inlet chamber (211).

Optionally, both the hot air support (200) and the blowing mechanism (300) are mounted on the case (120).

Optionally, the hot air support (200) is arranged on one side of the case (210).

Optionally, the hot air support (200) includes two separate hot air supports; and the two hot air supports are respectively arranged on two sides of the case (120).

Optionally, the hot air support (200) is annular; and the hot air support (200) is arranged on an outer side surface of the case (120) in a surrounding manner.

Optionally, the discharge heat preserving device further includes a controller (500) and a temperature sensor (600) arranged in the hot air support (200); and the controller (500) is connected to the temperature sensor (600), the heating part (400), and the nozzle device (110).

In some embodiments, the disclosure provides a discharge heat preserving method for a 3D printer where a hot airflow is blown to a discharge outlet of a nozzle device mounted on the 3D printer to form a heat preserving area at the discharge outlet of the nozzle device. Material discharged from the discharge outlet of the nozzle device stays in the heat preserving area for 2-10 s and the hot airflow is blown to the discharge outlet of the nozzle device from a lateral direction of the nozzle device.

Optionally, the material discharged from the discharge outlet of the nozzle device stays in the heat preserving area for 3-6 s.

In other embodiments, the disclosure provides a discharge heat preserving device for a 3D printer. A nozzle device is mounted on a case of the 3D printer. The discharge heat preserving device includes: a hot air support, a ventilation chamber being arranged in the hot air support and an air outlet of the ventilation chamber being located in a side surface of a discharge outlet of the nozzle device; a blowing mechanism driving an airflow to pass through the ventilation chamber; and a heating part mounted in the ventilation chamber to heat the airflow passing through the ventilation chamber. A hot airflow discharged from the ventilation chamber is blown to the discharge outlet of the nozzle device.

Optionally, an airflow discharge direction of the ventilation chamber is obliquely arranged relative to an axial direction of the nozzle device.

Optionally, the heating part includes a plurality of outlet air heating units and all outlet air heating units are sequentially arranged along an airflow discharge direction of the ventilation chamber.

Optionally, the ventilation chamber includes an air inlet chamber and an air outlet chamber communicated with each other; and all outlet air heating units are arranged in the air outlet chamber.

Optionally, the heating part further includes at least two inlet air heating units uniformly arranged in the air inlet chamber.

Optionally, all the inlet air heating units and the outlet air heating units are controlled electric heating devices.

Optionally, the air inlet chamber is located above the air outlet chamber and the blowing mechanism is located above the air inlet chamber.

Optionally, both of the hot air support and the blowing mechanism are mounted on the case.

Optionally, the hot air support is arranged on one side of the case; or when the number of the hot air supports is two, the two hot air supports are respectively arranged on two sides of the case; or when the hot air support is annular, the hot air support is arranged on an outer side surface of the case in a surrounding manner.

Optionally, the discharge heat preserving device for the 3D printer further includes a controller and a temperature sensor arranged in the hot air support, the controller being connected with the temperature sensor, the heating part, and the nozzle device.

### BRIEF DESCRIPTION OF THE DRAWINGS

Illustrative embodiments of the disclosure are described in detail below with reference to the figures.

FIG. 1 illustrates a side view of a discharge heat preserving system for a 3D printer according to an embodiment of the disclosure.

FIG. 2 illustrates a stereoscopic view of a discharge heat preserving system for a 3D printer according to an embodiment of the disclosure.

FIG. 3 illustrates a sectional view of a hot air support in a discharge heat preserving system for a 3D printer according to an embodiment of the disclosure.

FIG. 4 illustrates a bottom view of a discharge heat preserving system for a 3D printer according to an embodiment of the disclosure.

FIG. 5 illustrates a stereoscopic view of a hot air support in a discharge heat preserving system for a 3D printer according to an embodiment of the disclosure.

FIG. 6 illustrates a schematic diagram of a discharge heat preserving system for a 3D printer with a controller according to an embodiment of the disclosure.

### DETAILED DESCRIPTION

The following describes some non-limiting embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

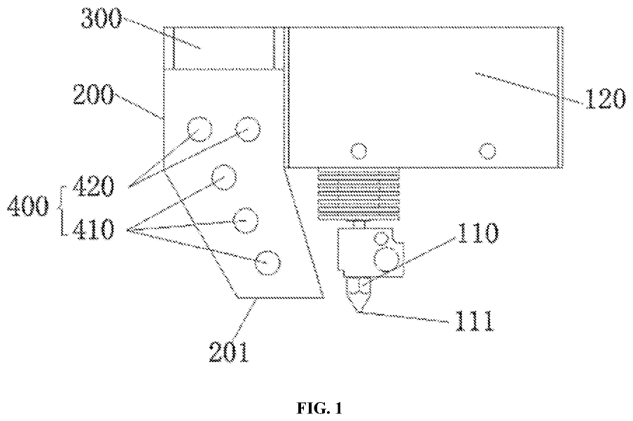

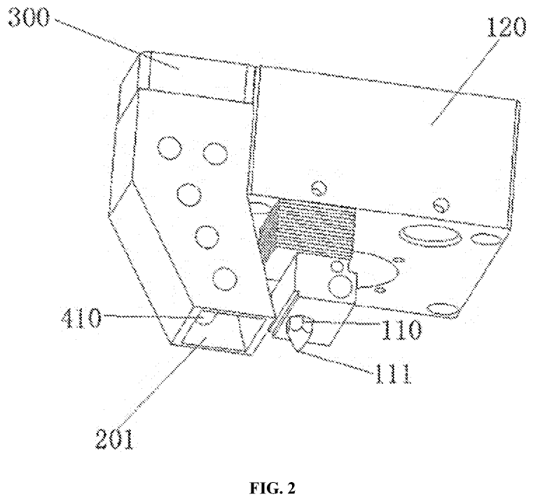

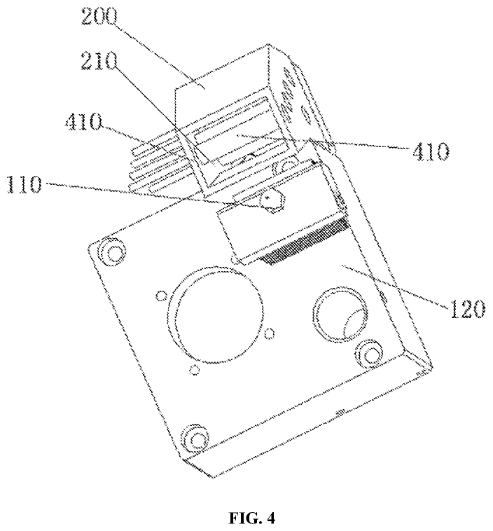

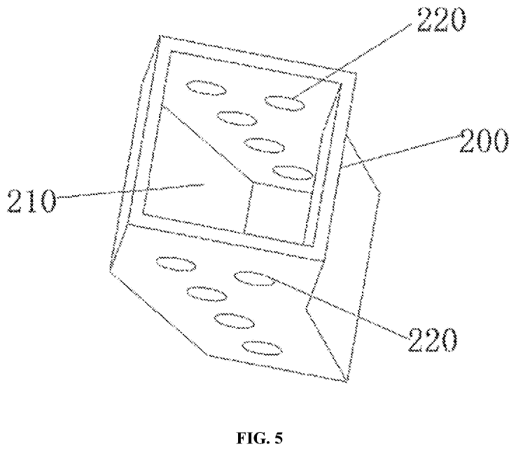

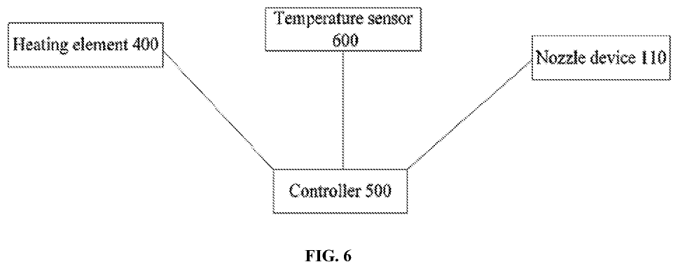

Referring to the drawings, it shall be noted that the structures, scales, sizes and the like illustrated in the drawings of the description are only used for cooperating with the contents disclosed by the description to allow one skilled in the art to understand and read instead of limiting the implementable limitation conditions of the disclosure, and thus have no technical substantive meanings; and any structural modifications, changes of scaling relations or adjustments to sizes shall still fall into the scope which may be covered by the technical contents disclosed by the disclosure under the situation that the effects which may be produced by the disclosure and the purposes which may be achieved by the disclosure are not influenced. In addition, words such as “above”, “below”, “left”, “right”, “middle”, and “one” cited in the description are just used for facilitating clear description instead of limiting the implementable scope of the disclosure. Changes or adjustments of relative relations thereof shall also be deemed as the implementable scope of the disclosure under the situation that the technical contents are not substantively changed. In FIGS. 1-6, 110 represents a nozzle device, 111 represents a discharge outlet, 120 represents a case, 200 represents a hot air support, 210 represents a ventilation chamber, 211 represents an air inlet chamber, 212 represents an air outlet chamber, 201 represents an air outlet, 220 represents a mounting through hole, 300 represents a blowing mechanism, 400 represents a heating part, 410 represents an outlet air heating unit, 420 represents an inlet air heating unit, 500 represents a controller, and 600 represents a temperature sensor.

As illustrated in FIGS. 1-6, in some embodiments, the disclosure may provide a discharge heat preserving device for a 3D printer. A hot airflow may be blown to a discharge outlet 111 of a nozzle device 110 mounted on the 3D printer to form a heat preserving area at the discharge outlet 111 of the nozzle device 110. Material discharged from the discharge outlet 111 of the nozzle device 110 may stay in the heat preserving area for 2-10 s and the hot airflow may be blown to the discharge outlet 111 of the nozzle device 110 from a lateral direction of the nozzle device 110.

In other embodiments, the hot airflow may be blown to the discharge outlet 111 of the nozzle device 110 to form the heat preserving area at the discharge outlet 111 of the nozzle device 110. The material discharged from the discharge outlet 111 of the nozzle device 110 may stay in the heat preserving area for 2-10 s such that the temperature of the material gradually decreases in the process from the moment that the material is discharged from the discharge outlet 111 to the moment that the material is solidified to the construction platform. Because the material is heated in the heat preserving area, The temperature of the material may gradually decrease, and thus may help to avoid the damage situations such as that the edge of the material is warped up and the material is broken after the material is solidified because now the temperature of the material does not rapidly decrease. Since the material may stay in the heat preserving area for 2-10 s, the heating of the material and the formation operation of the material on the construction platform may be simultaneously satisfied. The disclosure may meet printing demands of various materials, especially 3D printing demands of high-grade engineering plastic.

The material discharged from the discharge outlet 111 of the nozzle device 110 may stay in the heat preserving area for 3-6 s. Since the residence time is 3-6 s, not only various materials may be prevented from being damaged after the materials are heated by the hot airflow and are solidified, but also the formation efficiency of the materials on the construction platform may be guaranteed to be higher.

In further embodiments, the disclosure may disclose a discharge heat preserving device for a 3D printer where a nozzle device 110 is mounted on a case 120 of the 3D printer. The discharge heat preserving device may include: a hot air support 200, a ventilation chamber 210 being arranged inside the hot air support 200 and an air outlet 201 of the ventilation chamber 210 being located in a side surface of a discharge outlet 111 of the nozzle device 110; a blowing mechanism 300 driving airflow to pass through the ventilation chamber 210 and then discharge from the air outlet 201 the ventilation chamber 210; and a heating part 400 mounted in the ventilation chamber 210 to heat the airflow passing through the ventilation chamber 210. A hot airflow discharged from the ventilation chamber 210 may be blown to the discharge outlet 111 of the nozzle device 110.

The blowing mechanism 300 may drive the airflow to pass through the ventilation chamber 210. The heating part 400 may heat the airflow passing through the ventilation chamber 210. The hot airflow discharged from the ventilation chamber 210 may be blown to the discharge outlet 111 of the nozzle device 110 to form the heating preserving area at the discharge outlet of the nozzle device 110. The material discharged from the discharge outlet 111 of the nozzle device 110 may stay in the heat preserving area. The material is heated in the heat preserving area. As a result, the temperature of the material may gradually decrease in the printing process from the moment that the material is discharged from the discharge outlet 111 to the moment that the material is solidified to the construction platform, which may help to implement a stable 3D printing effect.

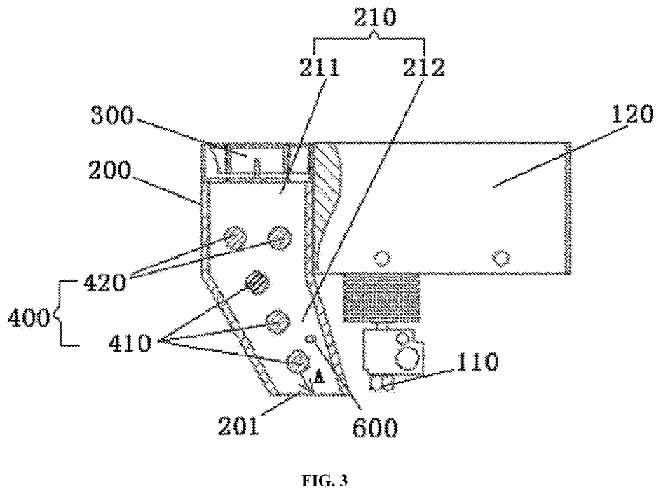

An airflow discharge direction of the ventilation chamber 210 may be obliquely arranged relative to an axial direction of the nozzle device 110. The staggered arrangement of airflow discharge direction of the ventilation chamber 210 and the axial direction of the nozzle device 110 may ensure that the hot airflow is stably blown to the discharge outlet 111 of the nozzle device 110. Here, the nozzle device 110 may be vertically arranged. The airflow discharge direction of the ventilation chamber 210 may be in direction A as illustrated in FIG. 3.

The heating part 400 may include a plurality of outlet air heating units 410 and all the outlet air heating units 410 may be sequentially arranged along an airflow discharge direction of the ventilation chamber 210. Such structure may enable the temperature of the airflow discharged from the ventilation chamber 210 to be kept stable.

The ventilation chamber 210 may include an air inlet chamber 211 and an air outlet chamber 212 communicated with each other. All the outlet air heating units 410 may be arranged in the air outlet chamber 212. The airflow may be accumulated in the air inlet chamber 211 and the airflow may be discharged from the air outlet chamber 212 to guarantee sufficient airflow volume. The airflow discharge direction of the ventilation chamber 210 may be the air discharge direction of the air outlet chamber 212. The air outlet 201 of the ventilation chamber 210 may be the air outlet 201 of the air outlet chamber 212.

The heating part 400 may further include at least two inlet air heating units 420 uniformly arranged in the air inlet chamber 211. The airflow may be heated by the inlet air heating units 420 in the air inlet chamber 211 such that the airflow entering the air outlet chamber 212 is the hot airflow and the temperature of the hot airflow discharged from the air outlet chamber 212 is more uniform.

All the inlet air heating units 420 and the outlet air heating units 410 may be controlled electric heating devices. When the controlled electric heating devices are powered on, heat is released to heat the airflow. The controlled electric heating devices may be heating rods, electric heating wires, et cetera. Here, the controlled electric heating devices may be heating rods, which are simple in structure and are convenient to arrange. A plurality of groups of opposite mounting through holes 220 into which two ends of the heating rods inserted may be arranged in the hot air support 200.

In order to facilitate the airflow to pass through the ventilation chamber 210 of the hot air support 200, the air inlet chamber 211 may be located above the air outlet chamber 212 and the blowing mechanism 300 may be located above the air inlet chamber 211. Here, the air inlet chamber 211 may be vertically arranged and the air outlet chamber 212 may be obliquely arranged relative to the air inlet chamber 211.

Both of the hot air support 200 and the blowing mechanism 300 may be mounted on the case 120. Such structure may enable the hot air support 200 and the blowing mechanism 300 to synchronously move with the case 120 and the nozzle device 110.

In order to enable the hot airflow to be collected at the air outlet 201 of the air outlet chamber 212, the size of the cross section of the air outlet chamber 212 may sequentially decrease along the airflow direction.

The hot air support 200 may be arranged on one side of the case 210 to facilitate the mounting of the hot air support 200. When the number of the hot air supports 200 is two, the two hot air supports 200 may be respectively arranged on two sides of the case 120 to implement the operation of blowing the hot airflow to the discharge outlet of the nozzle device 110 from the two sides of the case 120. When the hot air support 200 is annular, the hot air support 200 may be arranged on an outer side surface of the case 120 in a surrounding manner, and the annular hot air support 200 may effectively improve the flowrate of the hot airflow blown to the discharge outlet of the nozzle device 110.

In some embodiments, the discharge heat preserving device for the 3D printer may further include a controller 500 and a temperature sensor 600 arranged in the hot air support 200. The controller 500 may be connected with the temperature sensor 600, the heating part 400, and the nozzle device 110.

The temperature sensor 600 may send the measured temperature of the hot airflow in the hot air support 200 to the controller 500. When the controller 500 determines that the temperature of the hot airflow in the hot air support 200 reaches a preset temperature interval, the controller 500 turns on the nozzle device 110 to enable the discharge outlet of the nozzle device 110 to discharge the material. When the temperature of the hot airflow measured by the temperature sensor 600 is lower than a minimum temperature value of the preset temperature interval, the controller 500 may control the heating amount of the heating part 400 to increase the temperature of the hot airflow in the hot air support 200. The preset temperature interval in the controller may be set according to different choices of printing materials.

The above-mentioned embodiments are just used for exemplarily describing the principle and effect of the disclosure instead of limiting the disclosure. One skilled in the art may make modifications or changes to the above-mentioned embodiments without departing from the spirit and scope of the disclosure. Therefore, all equivalent modifications or changes made by those who have common knowledge in the art without departing from the spirit and technical thought disclosed by the disclosure shall be still covered by the claims of the disclosure.

Various embodiments of the disclosure may have one or more of the following effects.

In some embodiments, the disclosure provides a discharge heat preserving device for a 3D printer which may help to solve difficulties and overcome disadvantages in the prior art. The disclosure may have a great value for the industrial production.

In other embodiments, the disclosure provides a 3D printing process where hot airflow is blown to the discharge outlet of the nozzle device to form the heat preserving area at the discharge outlet of the nozzle device. The material discharged from the discharge outlet of the nozzle device stays in the heat preserving area such that the temperature of the material gradually decreases in the process from the moment that the material is discharged from the discharge outlet to the moment that the material is solidified to the construction platform, and thus may help to avoid the damage situations such as that the edge of the material is warped up and the material is broken after the material is solidified because now the temperature of the material does not rapidly decreases.

In further embodiments, the disclosure may satisfy printing demands of various materials, especially 3D printing demands of high-grade engineering plastic. The disclosure may save energy and reduce the production difficulties caused by heating the entire chamber to high temperature in the existing conventional methods. The disclosure may be convenient to mount and to maintain.

In some embodiments, the disclosure provides a discharge heat preserving system for a 3D printer where the heat preserving area may be formed at the discharge outlet (111) of the nozzle device (110). The material discharged from the discharge outlet (111) of the nozzle device (110) may stay in the heat preserving area and the material may be heated in the heat preserving area. The temperature of the material may gradually decrease, and thus may help to avoid the damage situations such as that the edge of the material is warped up and the material is broken after the material is solidified because now the temperature of the material does not rapidly decrease. Utilizing the discharge heat preserving method and device may save energy and reduce the production difficulty caused by heating of the entire chamber to high temperature.

In other embodiments, the disclosure provides a discharge heat preserving device for the 3D printer which may meet printing environment demands. The manufacturing demand may be lower, and the printing demands may be satisfied at extremely low energy consumption. The discharge material heat preserving device provided by the disclosure may fully replace the existing mode of heating the entire chamber, may have a remarkable energy saving effect, and may be convenient to mount and maintain.

Many different arrangements of the various components depicted, as well as components not shown, are possible without departing from the spirit and scope of the disclosure. Embodiments of the disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

1.-12. (canceled)

13. A discharge heat preserving method for a 3D printer, wherein:
a hot airflow is blown to a discharge outlet (111) of a nozzle device (110) mounted on the 3D printer to form a heat preserving area at the discharge outlet (111) of the nozzle device (110);
a printing material discharged from the discharge outlet (111) of the nozzle device (110) stays in the heat preserving area for 2-10 s; and
the hot airflow is blown to the discharge outlet (111) of the nozzle device (110) from a lateral direction of the nozzle device (110).

14. The discharge heat preserving method of claim 13, wherein the printing material discharged from the discharge outlet (111) of the nozzle device (110) stays for 3-6 s in the heat preserving area.

15. A discharge heat preserving system for a 3D printer, comprising:
a hot air support (200), wherein a ventilation chamber (210) is arranged inside the hot air support (200) and an air outlet (201) of the ventilation chamber (210) is located in a side surface of a discharge outlet (111) of a nozzle device (110);
a blowing mechanism (300) configured to drive an airflow to pass through the ventilation chamber (210); and
a heating part (400) mounted in the ventilation chamber (210) to heat the airflow passing through the ventilation chamber (210);
wherein:
the nozzle device (110) is mounted on a case (120) of the 3D printer; and
the heated airflow discharged from the ventilation chamber (210) is blown to the discharge outlet (111) of the nozzle device (110).

16. The discharge heat preserving system of claim 15, wherein an airflow discharge direction of the ventilation chamber (210) is obliquely arranged relative to an axial direction of the nozzle device (110).

17. The discharge heat preserving system of claim 15, wherein the heating part (400) comprises a plurality of outlet air heating units (410) sequentially arranged along an airflow discharge direction of the ventilation chamber (210).

18. The discharge heat preserving system of claim 17, wherein:
the ventilation chamber (210) comprises an air inlet chamber (211) and an air outlet chamber (212);
the air inlet chamber (211) and the air outlet chamber (212) are in communication with each other; and
the plurality of outlet air heating units (410) are arranged in the air outlet chamber (212).

19. The discharge heat preserving system of claim 18, wherein the heating part (400) further comprises at least two inlet air heating units (420) uniformly arranged in the air inlet chamber (211).

20. The discharge heat preserving system of claim 19, wherein the inlet air heating units (420) and the outlet air heating units (410) are electric heating devices.

21. The discharge heat preserving system of claim 18, wherein the air inlet chamber (211) is located above the air outlet chamber (212) and the blowing mechanism (300) is located above the air inlet chamber (211).

22. The discharge heat preserving system of claim 15, wherein both the hot air support (200) and the blowing mechanism (300) are mounted on the case (120).

23. The discharge heat preserving system of claim 15, wherein the hot air support (200) is arranged on one side of the case (210).

24. The discharge heat preserving system of claim 15, wherein:
the hot air support (200) include two separate hot air supports; and
the two hot air supports are respectively arranged on two sides of the case (120).

25. The discharge heat preserving system of claim 15, wherein:
the hot air support (200) is annular; and
the hot air support (200) is arranged on an outer side surface of the case (120) in a surrounding manner.

26. The discharge heat preserving system of claim 15, wherein:
the discharge heat preserving device further comprises a controller (500) and a temperature sensor (600) arranged in the hot air support (200); and
the controller (500) is connected to the temperature sensor (600), the heating part (400), and the nozzle device (110).
